(19) United States
(12) Patent Application Publication
(10) Pub. No.: US 2012/0242244 A1
(43) Pub. Date: Sep. 27, 2012

(54) INVERTER DEVICE AND ILLUMINATION DEVICE FOR USE IN DISPLAY DEVICE INCORPORATING SAME AND DISPLAY DEVICE

(75) Inventor: Shinji Matsumoto, Osaka-Shi (JP)

(73) Assignee: SHARP KABUSHIKI KAISHA, Osaka-Shi, Osaka (JP)

(21) Appl. No.: 13/512,639

(22) PCT Filed: Oct. 4, 2010
(86) PCT No.: PCT/JP2010/067331

§ 371 Date: May 30, 2012

(30) Foreign Application Priority Data
Dec. 10, 2009 (JP) 2009-280802

(51) Int. Cl. H05B 41/26

(52) U.S. Cl. 315/220

(57) ABSTRACT

In an inverter device which includes a plurality of transformers, in which output voltages of the transformers are used as input voltages that are input to a plurality of discharge tube lamps and which is used to drive the discharge tube lamps, at least one of drive frequencies of the transformers is different from the other drive frequencies.

### TECHNICAL FIELD

The present invention relates to an inverter device for driving a plurality of discharge tube lamps and an illumination device for use in a display device incorporating such an inverter device and a display device.

### BACKGROUND ART

An inverter device used in an illumination device for use in a display device applies a high-frequency high voltage to each of a plurality of discharge tube lamps, and thereby drives the discharge tube lamps. Thus, the discharge tube lamps are lit, and the illumination device for use in a display device functions as an illumination device.

In a conventional general inverter device, a plurality of discharge tube lamps are driven by a same-phase driving operation. An example of the configuration of the conventional general inverter device that performs the same-phase driving operation is shown in FIG. 7.

The inverter device shown in FIG. 7 is an inverter device for driving six discharge tube lamps (for example, cold-cathode tube lamps) L1 to L6. The inverter device includes: DC/AC conversion portions 1-1 to 1-6 that convert a direct-current input voltage Vin into high-frequency (for example, a few tens of kilohertz) alternating-current voltages; a step-up portion 2-k that steps up the output voltage Vk of the DC/AC conversion portion 1-k and that applies it to the discharge tube lamp Lk; and a control portion 3′ that controls the DC/AC conversion portions 1-1 to 1-6. Here, k is a natural number from 1 to 6.

The control portion 3′ controls the DC/AC conversion portions 1-1 to 1-6 such that the output voltages V1 to V6 of the DC/AC conversion portions 1-1 to 1-6 have the same frequency and phase. In this way, the output voltages (lamp application voltages) VL1 to VL6 of the step-up portions 2-1 to 2-6 have the same frequency and phase as shown in FIG. 8.

### RELATED ART DOCUMENT

### Patent Document

Patent document 1: JP-A-2005-283657

### DISCLOSURE OF THE INVENTION

### Problems to be Solved by the Invention

Since, as described above, the output voltages (lamp application voltages) VL1 to VL6 of the step-up portions 2-1 to 2-6 have the same frequency and phase, the electromagnetic waves (unnecessary radiation) generated from the transformers of the step-up portions 2-1 to 2-6 have the same frequency or an integral multiple thereof, with the result that the peak value of the unnecessary radiation in a predetermined frequency (the drive frequency of each of the transformers of the step-up portions 2-1 to 2-6) is disadvantageously increased.

Patent document 1 proposes an inverter device in which the same-phase driving operation is not performed, the phase of each of lamp application voltages is sequentially displaced by a phase difference corresponding to a time period T/N obtained by dividing one period T of the lamp application voltage by the number N of discharge tube lamps and thus the occurrence of noise resulting from leak current is prevented. The inverter device proposed in patent document 1 prevents the occurrence of noise resulting from leak current but does not prevent the peak value of unnecessary radiation in a predetermined frequency from being increased.

In view of the conditions described above, the present invention has an object to provide an inverter device that can reduce the peak of unnecessary radiation and an illumination device for use in a display device incorporating such an inverter device and a display device.

### Means for Solving the Problem

To achieve the above object, according to the present invention, there is provided an inverter device which includes a plurality of transformers, in which output voltages of the transformers are used as input voltages that are input to a plurality of discharge tube lamps and which is used to drive the discharge tube lamps, in which at least one of drive frequencies of the transformers is different from the other drive frequencies.

A case where a filter circuit or the like is provided between the transformers and the discharge tube lamps and where the output voltages of the transformers are applied to the discharge tube lamps through the filter circuit or the like is included in the configuration of “the inverter device in which output voltages of the transformers are used as input voltages that are input to a plurality of discharge tube lamps and which is used to drive the discharge tube lamps” described above.

The drive frequencies of the transformers may be different from each other.

To achieve the above object, the illumination device for use in a display device according to the present invention includes the inverter device of any one of the configurations described above and a plurality of discharge tube lamps that are driven by the inverter device.

To achieve the above object, the display device according to the present invention includes the illumination device for use in a display device configured as described above.

The display device may be a television receiver device.

### Advantages of the Invention

According to the present invention, since at least one of drive frequencies of a plurality of transformers incorporated in an inverter device is different from the other drive frequencies, the peak point of unnecessary radiation is smoothed out, and the peak value of the unnecessary radiation is lowered.

### BRIEF DESCRIPTION OF DRAWINGS

FIG. 1 A diagram showing the configuration of an inverter device according to an embodiment of the present invention;

FIG. 2 A diagram showing an example of the configuration of a DC/AC conversion portion;

FIG. 3 A diagram showing the unnecessary radiation of the inverter device shown in FIG. 1 and the unnecessary radiation of an inverter device shown in FIG. 7;

FIG. 4 A perspective view of the back surface side of an illumination device for use in a display device according to an embodiment of the present invention;

FIG. 5 A front view of the illumination device for use in a display device according to the embodiment of the present invention;

FIG. 6 An exploded perspective view of a liquid crystal television receiver device that is an example of the display device of the present invention;

FIG. 7 A diagram showing an example of the configuration of a conventional general inverter device that performs a same-phase driving operation; and

FIG. 8 A diagram showing the waveforms of lamp application voltages of the inverter device shown in FIG. 7.

### DESCRIPTION OF EMBODIMENTS

Embodiments of the present invention will be described below with reference to drawings.

### An Inverter Device According to an Embodiment of the Present Invention

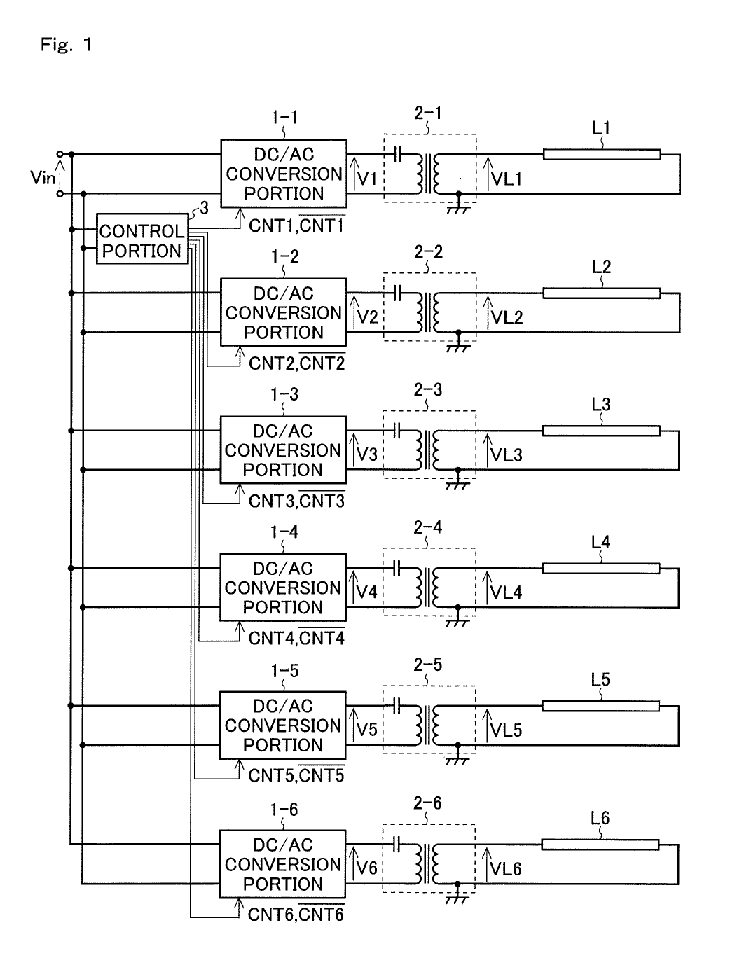

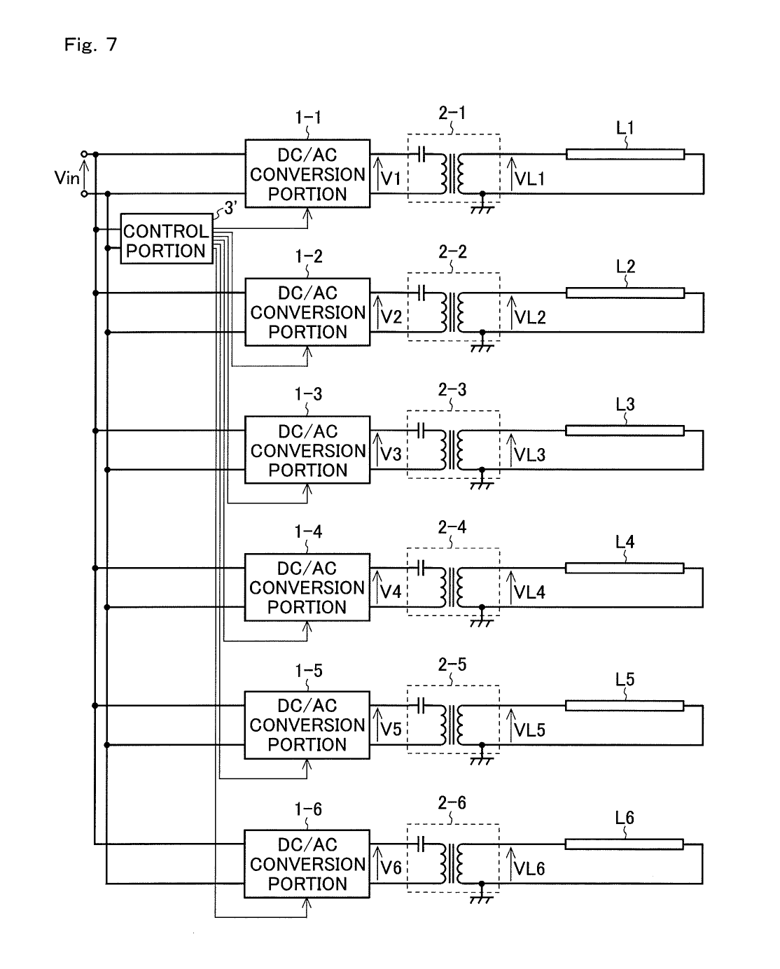

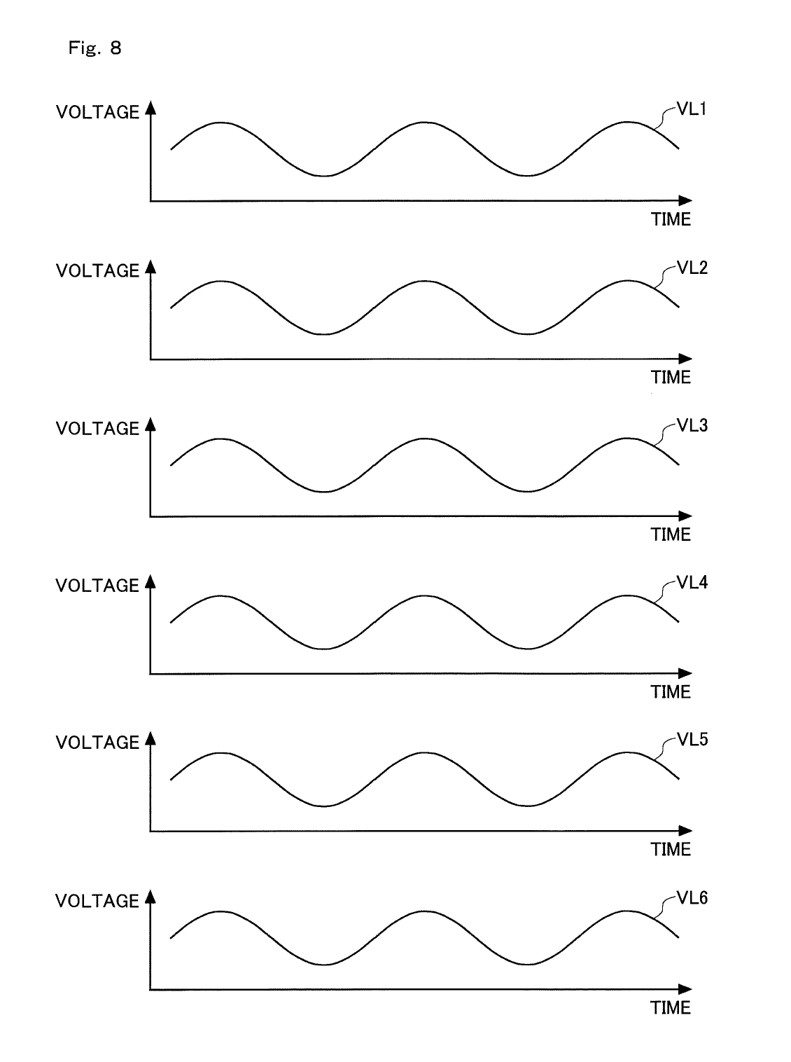

The configuration of an inverter device according to an embodiment of the present invention is shown in FIG. 1. In FIG. 1, the same parts as in FIG. 7 are identified with the same symbols, and their detailed description will not be repeated.

The inverter device shown in FIG. 1 and according to the embodiment of the present invention differs from the conventional general inverter device shown in FIG. 7 and performing the same-phase driving operation in that the control portion 3′ is removed and a control portion 3 is provided instead. The details of the control portion 3 will be described later.

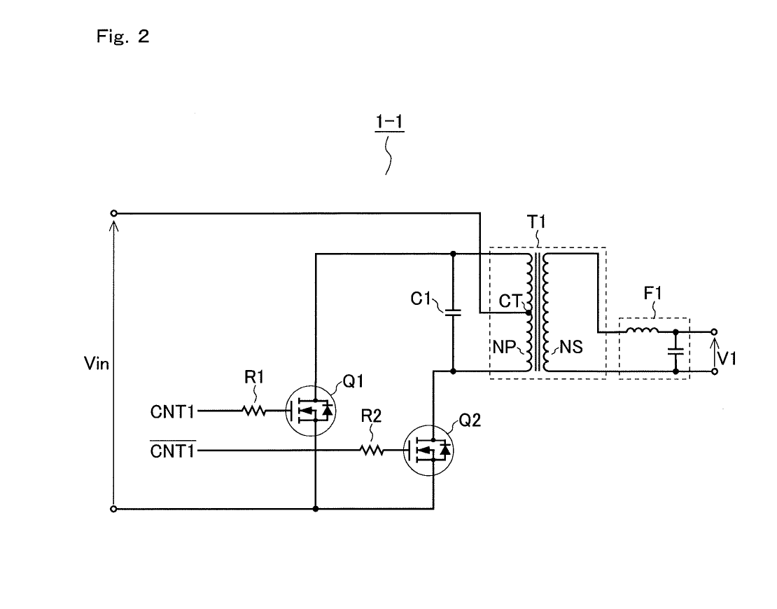

Here, an example of the configuration of the DC/AC conversion portion 1-1 included in the inverter device shown in FIG. 1 and according to the embodiment of the present invention is shown in FIG. 2. In the example of the configuration of FIG. 2, the DC/AC conversion portion 1-1 is a push-pull DC/AC conversion circuit, and includes switching elements Q1 and Q2, resistors R1 and R2, a capacitor C1, a transformer T1 and a low-pass filter circuit F1.

Each of the switching elements Q1 and Q2 is formed with an N-channel enhancement MOS transistor and a feedback diode that is inversely parallel connected to the transistor. A first PWM (pulse width modulation) control signal CNT1 output from the control portion 3 (see FIG. 1) is fed to the gate of the switching element Q1 through the resistor R1, and a first inversion PWM control signal bar CNT1 output from the control portion 3 is fed to the gate of the switching element Q2 through the resistor R2. Since the first inversion PWM control signal bar CNT1 is the inversion signal of the first PWM control signal CNT1, the switching elements Q1 and Q2 are complementarily turned on and off.

The transformer T1 has a primary winding NP and a secondary winding NS, and a center tap CT is provided in the primary winding NP. The drain of the switching element Q1 and one end of the capacitor C1 are connected to one end of the primary winding NP, the drain of the switching element Q2 and the other end of the capacitor C2 are connected to the other end of the primary winding NP and the source of the switching element Q1 and the source of the switching element Q2 are connected in common. A direct-current input voltage Vin is applied between its common connection point and the center tap CT.

The switching elements Q1 and Q2 are complementarily turned on and off, and thus a current alternately flows through a connection line between the drain of the switching element Q1 and one end of the primary winding NP and a connection line between the source of the switching element Q1 and the source of the switching element Q2, and the direction in which the current flows through the primary winding NP is switched, with the result that a voltage having a rectangular waveform is produced between both ends of the secondary winding NS. The voltage having a rectangular waveform produced between both ends of the secondary winding NS is converted by the low-pass filter circuit F1 into a sinusoidal voltage V1. The leakage inductor of the transformer T1 may be used as an inductor that is a constituent element of the low-pass filter circuit F1.

The sinusoidal voltage V1 output from the DC/AC conversion portion 1-1 is stepped up by the step-up portion 2-1 (see FIG. 1) into a sinusoidal high voltage VL1, and the sinusoidal high voltage VL1 is applied between both ends of the discharge tube lamp L1 (see FIG. 1).

An example of the configuration of each of the DC/AC conversion portions 1-2 to 1-6 is the same as the example of the configuration of the DC/AC conversion portion 1-1 shown in FIG. 2, and thus their description will not be repeated.

The control portion 3 will now be described. The control portion 3 generates the first PWM control signal CNT1 and the first inversion PWM control signal bar CNT1 and outputs them to the DC/AC conversion portion 1-1, generates a second PWM control signal CNT2 and a second inversion PWM control signal bar CNT2 and outputs them to the DC/AC conversion portion 1-2, generates a third PWM control signal CNT3 and a third inversion PWM control signal bar CNT3 and outputs them to the DC/AC conversion portion 1-3, generates a fourth PWM control signal CNT4 and a fourth inversion PWM control signal bar CNT4 and outputs them to the DC/AC conversion portion 1-4, generates a fifth PWM control signal CNT5 and a fifth inversion PWM control signal bar CNT5 and outputs them to the DC/AC conversion portion 1-5 and generates a sixth PWM control signal CNT6 and a sixth inversion PWM control signal bar CNT6 and outputs them to the DC/AC conversion portion 1-6.

<An Example of the Operation of the Control Portion>

The control portion 3 generates the control signals CNT1 to CNT6 and the bars CNT1 to CNT6 such that, as shown in Table 1 below, specifically, the drive frequency f1 (=the frequency of the lamp application voltage VL1) of the transformer of the step-up portion 2-1 and the drive frequency f2 (=the frequency of the lamp application voltage VL2) of the transformer of the step-up portion 2-2 are displaced by 1 kHz, that the drive frequency f2 (=the frequency of the lamp application voltage VL2) of the transformer of the step-up portion 2-2 and the drive frequency f3 (=the frequency of the lamp application voltage VL3) of the transformer of the step-up portion 2-3 are displaced by 1 kHz, that the drive frequency f3 (=the frequency of the lamp application voltage VL3) of the transformer of the step-up portion 2-3 and the drive frequency f4 (=the frequency of the lamp application voltage VL4) of the transformer of the step-up portion 2-4 are displaced by 1 kHz, that the drive frequency f4 (=the frequency of the lamp application voltage VL4) of the transformer of the step-up portion 2-4 and the drive frequency f5 (=the frequency of the lamp application voltage VL5) of the transformer of the step-up portion 2-5 are displaced by 1 kHz and that the drive frequency f5 (=the frequency of the lamp application voltage VL5) of the transformer of the step-up portion 2-5 and the drive frequency f6 (=the frequency of the lamp application voltage VL6) of the transformer of the step-up portion 2-6 are displaced by 1 kHz. This can be easily achieved by making a setting such that the PWM period of the k-th PWM control signal CNTk and the k-th inversion PWM control signal bar CNTk differs depending on an individual value of k basis. Here, k is a natural number from 1 to 6.

TABLE 1

| | |
|---|---|
| f1 | 31 |
| f2 | 32 |
| f3 | 33 |
| f4 | 34 |
| f5 | 35 |
| f6 | 36 |

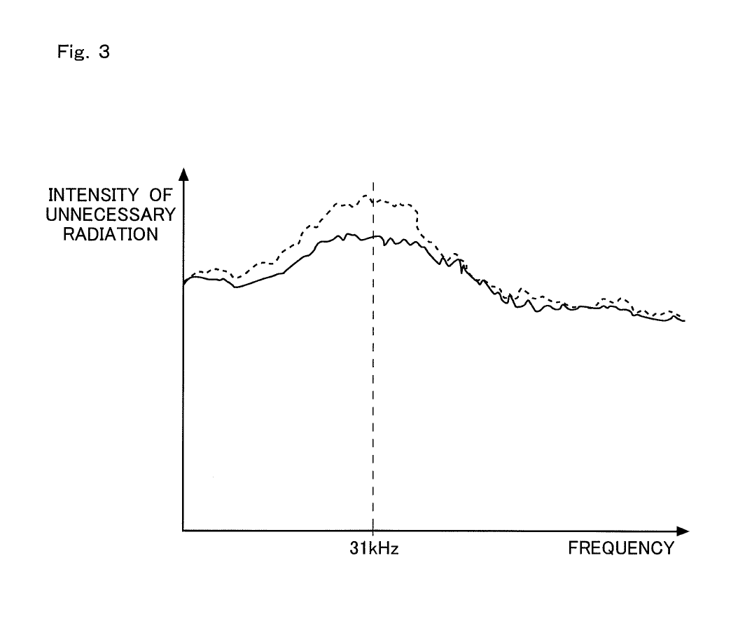

The results of comparison between the unnecessary radiation of the inverter device shown in FIG. 1 and according to the embodiment of the present invention and the unnecessary radiation of the conventional general inverter device that converts the frequency of the lamp application voltages VL1 to VL6 into 31 kHz and that is shown in FIG. 7 are now shown in FIG. 3. In FIG. 3, the solid line represents the unnecessary radiation of the inverter device shown in FIG. 1 and according to the embodiment of the present invention, and the dotted line represents the unnecessary radiation of the conventional general inverter device shown in FIG. 7.

In the inverter device shown in FIG. 1 and according to the embodiment of the present invention, since the drive frequencies f1 to f6 (=the frequencies of the lamp application voltages VL1 to VL6) of the transformers of the step-up portions 2-1 to 2-6 differ from each other, as obvious from FIG. 3, as compared with the conventional general inverter device shown in FIG. 7, the peak point of the unnecessary radiation is smoothed out, and the peak value of the unnecessary radiation is lowered.

<A Variation of the Operation of the Control Portion>

Although, in Table 1 above, the difference between the drive frequencies f1 and f2 of the transformers, the difference between the drive frequencies f2 and f3 of the transformers, the difference between the drive frequencies f3 and f4 of the transformers, the difference between the drive frequencies f4 and f5 of the transformers and the difference between the drive frequencies f5 and f6 of the transformers are 1 kHz, the present invention is not limited to this setting. In other words, the amount of difference between the drive frequencies f1 and f2 of the transformers, the amount of difference between the drive frequencies f2 and f3 of the transformers, the amount of difference between the drive frequencies f3 and f4 of the transformers, the amount of difference between the drive frequencies f4 and f5 of the transformers and the amount of difference between the drive frequencies f5 and f6 of the transformers are not particularly limited. The amounts of differences may be equal to each other as shown in Table 1; each of or part of the amounts of differences may differ.

Although, in Table 1 above, the drive frequencies f1 to f6 (=the frequencies of the lamp application voltages VL1 to VL6) of the transformers of the step-up portions 2-1 to 2-6 differ from each other, the present invention is not limited to this setting. Preferably, at least one of the drive frequencies f1 to f6 (=the frequencies of the lamp application voltages VL1 to VL6) of the transformers of the step-up portions 2-1 to 2-6 differs from the other ones.

### An Illumination Device for Use in a Display Device According to an Embodiment of the Present Invention

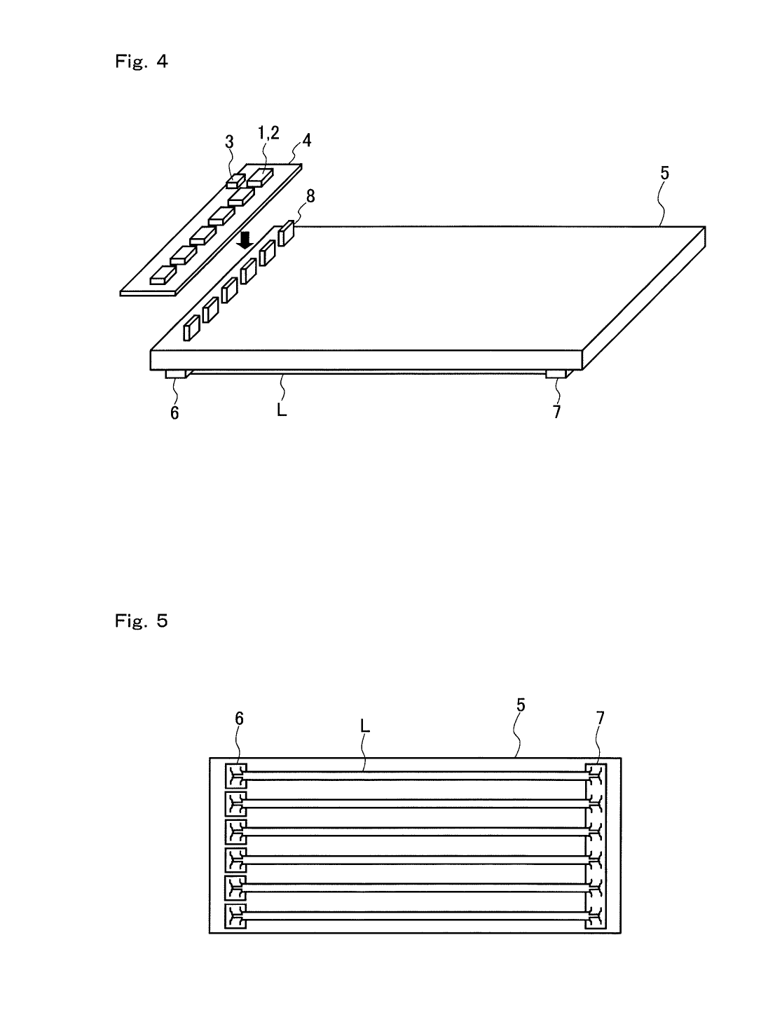

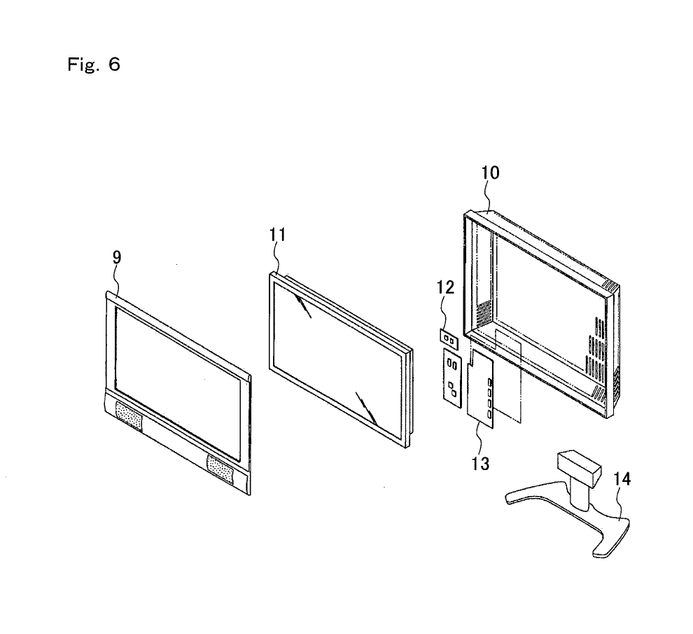

FIG. 4 shows a perspective view of the back surface side of an illumination device for use in a display device according to an embodiment of the present invention; FIG. 5 shows a front view. In FIG. 4, the same parts as in FIG. 1 are identified with the same symbols. In FIGS. 4 and 5, symbol 1 represents any one of symbols 1-1 to 1-6 (see FIG. 1), symbol 2 represents any one of symbols 2-1 to 2-6 (see FIG. 1) and symbol L represents any one of symbols L1 to L6 (see FIG. 1).

The illumination device for use in a display device shown in FIGS. 4 and 5 and according to the embodiment of the present invention includes the inverter device shown in FIG. 1 and according to the embodiment of the present invention (hereinafter referred to as an “inverter device”), an inverter substrate 4, a chassis 5 and six discharge tube lamps L.

The inverter device is mounted on the inverter substrate 4.

One end of each of the discharge tube lamps L is held to one of first holding units 6 provided on the front surface of the chassis 5; the other end of each of the discharge tube lamps L is held to a second holding unit 7 provided on the front surface of the chassis 5. On the back surface of the chassis 5, six connectors 8 are provided in positions corresponding to the first holding units 6. Terminals on the side of the one end of each of the discharge tube lamps L are electrically connected through the conductive first holding units 6 to the connector terminals of the connectors 8; the terminals on the side of the other end of each of the discharge tube lamps L are connected in common through the conductive second holding unit 7 to a ground potential.

In the inverter substrate 4, on the surface opposite the mounting surface of the inverter device, inverter-side connectors (not shown) that pair with the connectors 8 are provided. One of the output terminals of each of the step-up portions 2 is electrically connected to the connector terminal of each of the inverter-side connectors; the other output terminal of each of the step-up portions 2 is connected to the ground potential.

When the inverter substrate 4 is attached to the back surface of the chassis 5 in a direction indicated by an arrow of FIG. 4, the connectors 8 of the chassis 5 are connected to the inverter-side connectors (not shown) of the inverter substrate 4. This connection allows a plurality of discharge tube lamps L to be driven by the inverter device.

### A Display Device According to an Embodiment of the Present Invention

A display device according to an embodiment of the present invention includes the illumination device for use in a display device shown in FIGS. 4 and 5 and according to the embodiment of the present invention and a display panel. As a specific aspect of the display device according to the embodiment of the present invention, for example, there is provided a transmission liquid crystal display device in which the illumination device for use in a display device shown in FIGS. 4 and 5 and according to the embodiment of the present invention is used a backlight unit and in which a liquid crystal display panel is provided on the front surface of the backlight unit.

FIG. 6 shows an example of an exploded perspective view when the display device according to the embodiment of the present invention is a liquid crystal television receiver device. Between a front cabinet 9 and a rear cabinet 10, a transmission liquid crystal display portion 11, a tuner 12 and a power supply 13 are housed, and the rear cabinet 10 is held by a stand 14. The transmission liquid crystal display portion 11 uses, as a backlight unit, the illumination device for use in a display device shown in FIGS. 4 and 5 and according to the embodiment of the present invention; a liquid crystal display panel is provided on the front surface of the backlight unit. The power supply 13 converts a commercial alternating-current voltage into a direct-current voltage, and supplies the direct-current voltage to portions such as the transmission liquid crystal display portion 11 and the tuner 12.

<<Others>>

Although the embodiments of the present invention have been described above, the scope of the present invention is not limited to these embodiments. Various variations are possible without departing from the spirit of the present invention. For example, a filter circuit or the like may be provided between the step-up portions 2-1 to 2-6 of the inverter device according to the embodiment of the present invention and the discharge tube lamps L1 to L6.

### INDUSTRIAL APPLICABILITY

The inverter device of the present invention can be utilized to drive a plurality of discharge tube lamps.

### LIST OF REFERENCE SYMBOLS

1, 1-1 to 1-6 DC/AC conversion portion
2, 2-1 to 2-6 step-up portion
3, 3′ control portion
4 inverter substrate
5 chassis
6 first holding unit
7 second holding unit
8 connector
9 front cabinet
10 rear cabinet
11 transmission liquid crystal display portion
12 tuner
13 power supply
14 stand
C1 capacitor
CT center tap
F1 low-pass filter circuit
L, L1 to L6 discharge tube lamp
NP primary winding
NS secondary winding
Q1, Q2 switching element
R1, R2 resistor
T1 transformer

1. An inverter device which includes a plurality of transformers, in which output voltages of the transformers are used as input voltages that are input to a plurality of discharge tube lamps and which is used to drive the discharge tube lamps,
wherein at least one of drive frequencies of the transformers is different from the other drive frequencies.

2. The inverter device of claim 1,
wherein the drive frequencies of the transformers are different from each other.

3. An illumination device for use in a display device comprising:
the inverter device of claim 1; and
a plurality of discharge tube lamps that are driven by the inverter device.

4. A display device comprising:
the illumination device for use in a display device according to claim 3.

5. The display device of claim 4,
wherein the display device is a television receiver device.
